(19) United States
(12) Patent Application Publication
(10) Pub. No.: US 2004/0195912 A1
(43) Pub. Date: Oct. 7, 2004

(54) Valve booster

(76) Inventor: Bruno Beylerian, Louvres (FR)

Correspondence Address: Leo McCormick Jr, P O Box 4721, 2112 Mishawaka Avenue, South Bend, IN, 46634-4721, US

(21) Appl. No.: 10/486,431

(22) PCT Filed: Jul. 30, 2002
(86) PCT No.: PCT/FR02/02727

(30) Foreign Application Priority Data
Aug. 8, 2001 (FR) 01/10617

(51) Int. Cl. B60T 8/44

(52) U.S. Cl. 303/114.1

(57) ABSTRACT

The invention relates to a pneumatic brake booster comprising in particular a rigid casing (1), a moving partition (2), a front chamber (3) subjected to a depression (Pd), a rear chamber (4) subjected at will to the depression or to atmospheric pressure (Pa), a pneumatic piston (5), a control rod (7), a plunger (8), a three-way valve (9) and a reaction disc (13). The valve (9) essentially comprises two valve elements (61, 62) which are articulated to a lever (90) mounted so that it can rock with respect to the control rod (7) and which are pressed on their respective seats (51, 52) by movements in opposite directions, one (61) of the valve elements controlling a communication passage (11) connecting the rear (4) and front (3) chambers and the other valve element (62) controlling a communication passage (12) connecting the rear chamber (4) to atmospheric pressure (Pa).

The present invention relates, in general, to the technical field of motor vehicle braking systems.

More specifically, the invention relates to a pneumatic brake booster comprising: a rigid casing; a moving partition sealingly delimiting a front chamber and a real chamber inside the rigid casing, the front chamber being connected, in an operational situation, to a pressure source delivering a first pressure, and the rear chamber being selectively connected to the front chamber or subjected to a pressure controlled by being placed selectively in communication with a second pressure higher than the first; a pneumatic piston moving with the moving partition; a control rod adopting, in the piston, a relative position dependent at least on an actuating force applied selectively to the control rod in an axial actuating direction directed towards the front chamber, and on an antagonistic return force directed in an axial return direction; a plunger housed in the piston and driven by the control rod; a three-way valve controlling the pressure in the rear chamber, this valve selectively connecting the rear chamber to the front chamber or to the second pressure according to whether the control rod is adopting, with respect to the piston, a relative rear position under the effect at least of the return force, or a relative actuating position under the effect of the actuating force; and a reaction member receiving and transmitting the actuating force applied by the plunger and a boost force applied by the piston and resulting from an effort exerted by the controlled pressure on the moving partition.

Although devices of this type are known and have been used successfully for decades, they continue to form the object of much research effort in an attempt to optimize their performance.

The present invention, which falls squarely within this context, has the purpose of providing a booster which differs from the known boosters, in terms of its performance or of its bulk, at least either by having a shorter dead travel or by having a shorter response time or by having a smaller difference between the operating effort and the return effort, or by having a narrow diameter of the piston shank, and possibly by having several of these features.

To this end, the booster according to the invention, in other respects in accordance with the generic definition given thereof in the above preamble, is essentially characterized in that the valve comprises a lever mounted so that it can rock with respect to the control rod and having, on each side of the control rod, first and second level arms respectively ending in first and second ends, first and second valve seats defined in the piston, first and second valve elements articulated to the respective first and second ends of the level and applied selectively to the respective first and second seats by relative movements directed respectively in the axial actuating direction and in the axial return direction, a first communication passage connecting the rear and front chambers through the first valve seat, a second communication passage connecting the rear chamber to the second pressure through the second valve seat, a spring urging at least the first lever arm in the axial return direction, and a stop halting the movement of the first lever arm in the axial return direction when the control rod is in the rest position.

In one possible embodiment of the invention, the valve elements are articulated to the lever by means of respective rods, and the stop is formed by a continuation of the rod of the first valve element coming into contact with the rigid cacing when the control rod is in the rest position.

The abovementioned spring may, for its part, consist of a helical spring stressed in compression and arranged between the piston and the lever.

To give the rear chamber the required sealing it is possible to make provision for the piston to have a piston shank passing with sealing through an opening made in the casing, for the control rod to be secured to a sleeve tube having two ends via which this sleeve tube is mounted to slide with sealing in the piston shank, in that a ring is mounted to pivot on a central external surface of the sleeve tube, and in that the two lever arms of the lever are fixed to the ring and pass through respective axial slots made in the piston shank and situated in the rear chamber.

Furthermore, to allow the assembly to be assembled, the ring is, for example, formed of two ring halves slipped over pivots projecting from the central external surface of the sleeve tube and connected together by means of two connections via which the lever arms are fixed to the ring.

Other features and advantage of the invention will become clearly apparent from the description given hereinafter by way of entirely nonlimiting indication with reference to the attached drawings, in which:

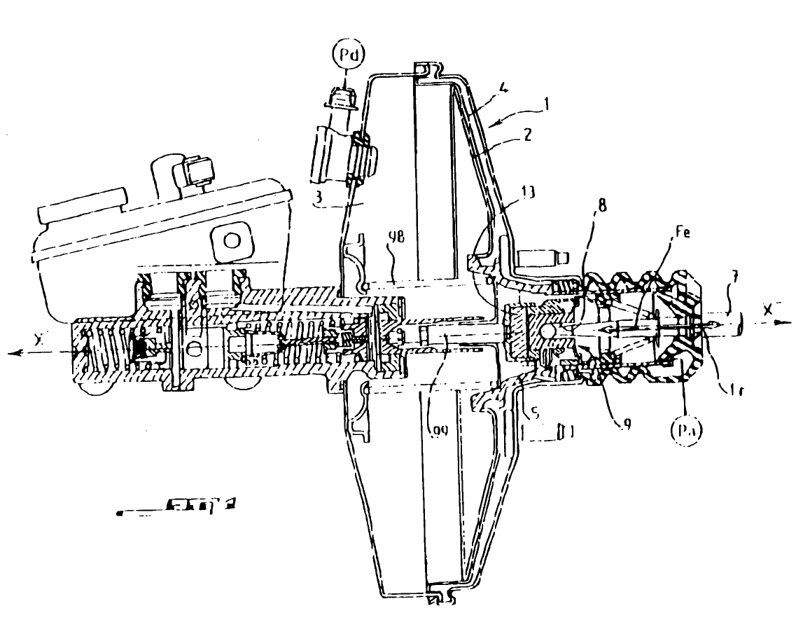

FIG. 1 is a view in axial section of a known booster, depicted with the master cylinder it is able to actuate;

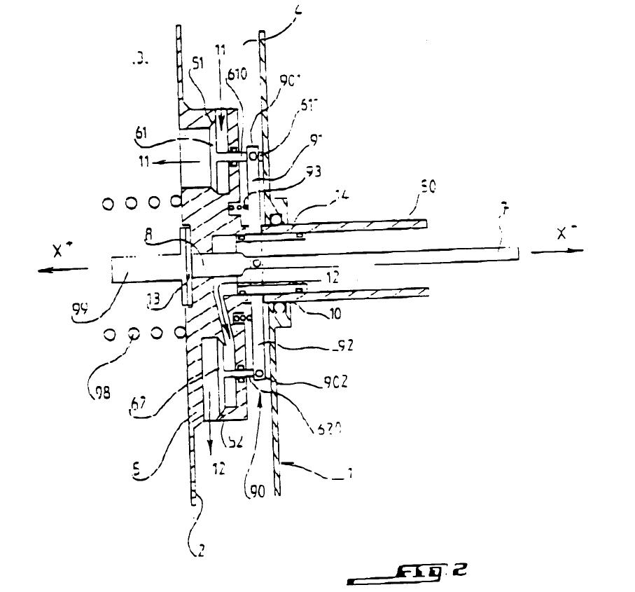

FIG. 2 is a schematic part view in axial section of a booster according to the invention, depicted in the grasp position;

FIG. 3 is a schematic part view in axial section of the booster of FIG. 2, depicted in the actuating phase;

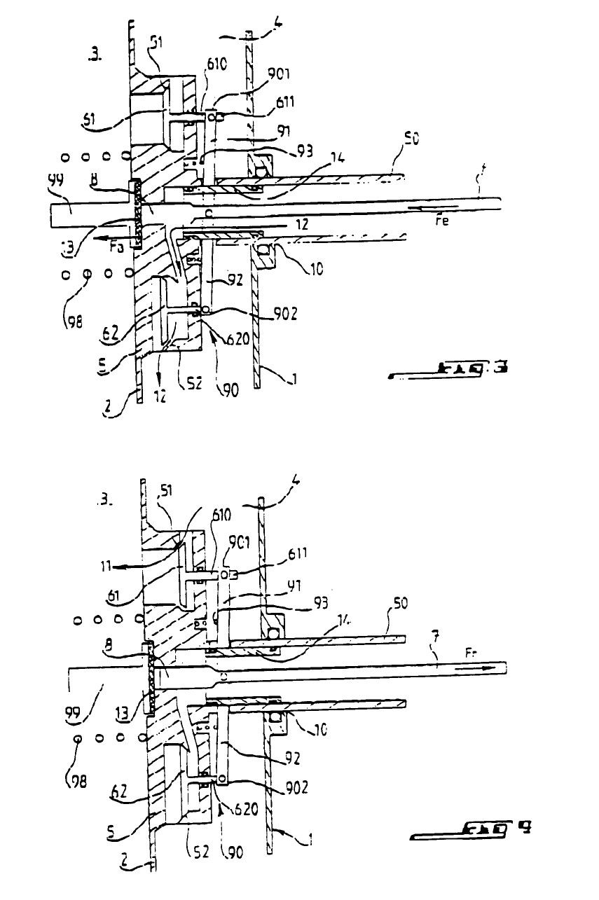

FIG. 4 is a schematic part view in axial section of the booster of FIG. 2, depicted in the return phase;

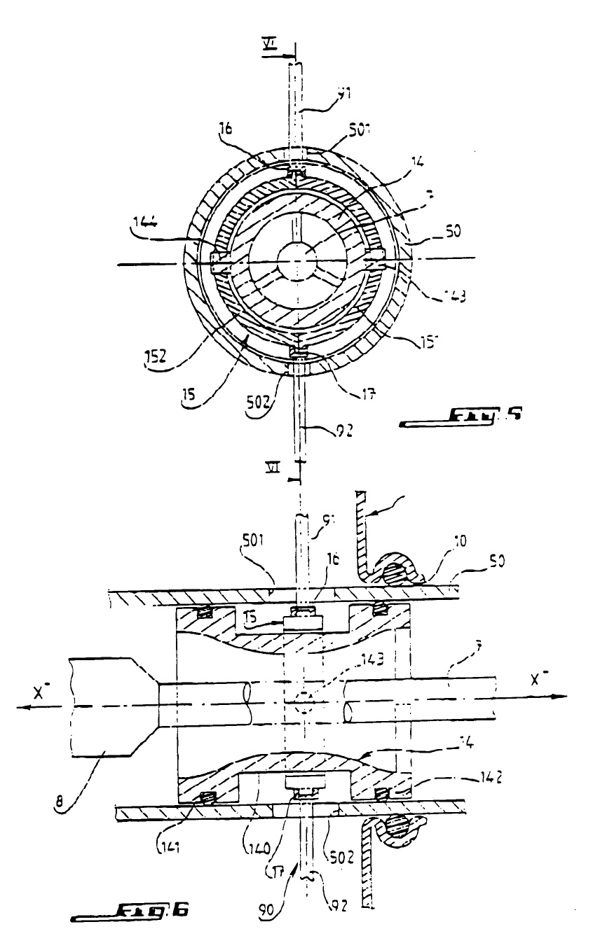

FIG. 5 is a part view in cross section of one particular embodiment of a booster according to the invention, the section being taken in the plane of the lever; and

FIG. 6 is a part view in axial section of the booster illustrated in FIG. 5, this booster being observed in the direction defined by the arrows VI-VI in FIG. 5.

As previously stated, the invention relates to a pneumatic brake booster.

In the traditional way and as shown by FIG. 1, such a booster essentially comprises a rigid casing 1, a moving partition 2, a front chamber 3, a rear chamber 4, a pneumatic piston 5, a control rod 7, a plunger 8, a three-way valve 9, and a reaction member 13, for example a reaction disc made of rubber.

The front 3 and rear 4 chambers are delimited in a sealed way, within the rigid casing 1, by the moving partition 2, these chambers therefore having variable and complementing respective volumes.

The control rod 7 is slidably mounted in the piston 5, and with respect to this piston adopts a position which depends in particular on an actuating force Fe which may be applied to the control rod 7 in an axial actuating direction X+, and on an antagonistic return force Fr, exerted by a spring 98, and directed in an axial return direction X−.

The plunger 8, which is housed in the piston 5, is driven by the control rod 7 and controls the three-way valve 9, the latter controlling the pressure in the rear chamber 4.

More specifically, the valve 9 connects the rear chamber 4 either to the front chambers or to the second pressure Pa, depending on whether the control rod 7 is adopting, with respect to the piston 5, a relative rest position under the affect of the return force Fr, or an actuating position under the effect of the actuating force Fe.

When the booster is placed in its operational environment, the front chamber 3 is connected permanently to a source of pneumatic depression, such as the intake to a combustion engine, or a vacuum pump, delivering a low pressure Pd.

When the booster is at rest, the rear chamber 4 is connected to the front chamber 3, and therefore subjected to the depression Pd in the front chamber.

When the booster is actuated by application of the actuating force Fe, the rear chamber 4 is subjected to a controlled pressure by being placed in communication with a second pressure Pa higher than the first Pd, for example with the atmosphere, the difference between the pressures Pa and Pd then allowing a boost force Fa to appear, which boost force is exerted on the moving partition 2 and applied to the disc 13 by the pneumatic piston 5, which moves with the moving partition 2.

Finally, the reaction disc 13 receives and transmits to a push rod 99 the actuating force Fe which applied [ [symbol] ] by the plunger 8 and the boost force Fa exerted by the piston 5.

According to the invention, the valve 9 essentially comprises a lever 90, two valve seats 51 and 52, two valve elements 61 and 62, two communication passages 11 and 12, a spring 93 and a stop 611.

The lever 90 is mounted to rock with respect to the control rod 7 and, on each side of the control rod, has identical and opposed lever arms 91 and 92, the ends of which form the ends 901 and 902 of the lever 90.

The valve elements 61 and 62 are articulated to the respective ends 901 and 902 of the lever 90 and can press against the respective seats 51 and 52 which are both formed in the pneumatic piston 5.

More specifically, the valve element 61 can be pressed against the seat 51 by a movement in the axial actuating direction X+, whereas the valve element 62 can be pressed against the seat 52 by a movement in the axial return direction X−.

Furthermore, the communication passage 11 connects the rear 4 and front 3 chambers through the valve seat 51, whereas the communication passage 12 connects the rear chamber 4 to the second pressure Pa through the second valve seat 52.

The spring 93 has the purpose of urging the lever arm 91 in the axial return direction X−, this spring for example consisting of a helical spring stressed in compression and arranged between the piston 5 and the lever 90.

The stop 611 for its part has the function of halting the movement of the lever arm 91 in the axial return direction X− when the control rod 7 is in the rear position.

The way in which the booster of the invention works is illustrated by FIGS. 2 to 4.

When the booster is at rest (FIG. 2), the spring 98 pushes the piston 5 back in the return direction X−.

The lever arm 91, immobilized by the stop 611, pushes the valve element 61 against the seat 51, the lever arms 92 symmetrically pulling the valve element 62 towards the seat 52.

When an actuating force Pa is exerted on the control rod 7 (FIG. 3), this rod moves in the piston 5 in the actuating direction X+.

However, since the valve element 61 is already pressed against the seat 51, the relative movement of the rod 7 and of the piston 5 can take place only to the extent that the lever 90 rocks with respect to the rod, this having the effect that the lever arm 92 lifts the valve element 62 off its seat 52.

The communication passage 12 is then opened, and atmospheric air, available outside the rigid casing 1, is let into the rear chamber 4 through this second communication passage.

When the actuating force Fe disappears (FIG. 4), the control rod 7, urged by the force exerted by the spring 93, moves in the return direction X− with respect to the piston 5.

Initially, this relative movement of the rod 7 with respect to the piston 5 causes the valve element 62 to be applied against the valve seat 52, the communication passage 12 thus being cut off, and the rear chamber 4 thus being isolated from atmospheric air.

As soon as the valve seat 52 is shut off by the valve element 62, the subsequent relative movement of the rod 7 with respect to the piston 5 under the effect of the force exerted by the spring 93 then causes the lever 90 to rock with respect to the rod 7 in a direction such that the lever arm 91 lifts the valve element 61 off the seat 51.

The communication passage 11 is then opened, and the rear chamber 4 is subjected to the pressure Pd in the front chamber 3.

Finally, the return force Fr exerted by the spring 96 allows the piston 5 to be returned to its rest position, moving it in the return direction X−.

As FIGS. 2 to 4 show, the valve elements 61, 62 are, for example, articulated to the lever 90 by means of respective rods 610 and 620.

The stop 611 can then, for example, be formed of a continuation of the rod 610 of the valve element 61, which comes into contact with the rigid casing 1 when the control rod 7 is in the rest position.

One exemplary practical embodiment of the invention is illustrated in FIGS. 5 and 6, in the conventional case where the piston 5 has a piston shank 50 mounted to slide with sealing in an opening 10 made in the rigid casing.

According to this embodiment, the control rod 7 is secured to a hollow sleeve tube 14 which is mounted to slide with sealing in the piston shank 50 via its two ends 141 and 142.

Between its ends 141 and 142, the sleeve tube 14 has an essentially cylindrical and continuous central external surface 140, of small diameter, from which there project two pivots, 143 and 144, which are aligned with one another in the mid-plane of the sleeve tube 14 and face away from each other.

A ring 15, formed of two ring halves 151 and 152 respectively slipped over the pivots 143 and 144, is mounted to pivot on the central external surface 140 of the sleeve tube 14.

The ring halves 151 and 152 are connected together by means of respective connections 16 and 17, by virtue of which the layer arms 91 and 92 of the lever 90 are respectively fixed to the ring 15.

Finally, these lever arms 91 and 92 pass through respective axial slots 501 and 502 made in the piston shank 50 and situated in the rear chamber 4.

Thus, in spite of there being the slots 501 and 502 made in the piston shank 50, the sealing afforded between each of the ends 141 and 142 of the sleeve tube 14 and the internal surface of the piston shank 50 makes it possible to ensure that the only possible passage for communication between the rear chamber 4 and the atmosphere Pa is via the communication passage 12 which passes between the seat 52 and the valve element 62.

We claim:

1. A pneumatic brake booster comprising: a rigid casing (1); a moving partition (2) sealingly delimiting a front chamber (3) and a rear chamber (4) inside the rigid casing (1), the front chamber (3) being connected, in an operational situation, to a pressure source delivering a first pressure (Pd), and the rear chamber (4) being selectively connected to the front chamber (3) or subjected to a pressure controlled by being placed selectively in communication with a second pressure (Pa) higher than the first (Pd); a pneumatic piston (5) moving with the moving partition (2); a control rod (7) adopting, in the piston (5), a relative position dependent at least on an actuating force (Fe) applied selectively to the control rod (7) in an axial actuating direction (X+) directed towards the front chamber (3), and on an antagonistic return force (Fr) directed in an axial return direction (X−); a plunger (8) housed in the piston (5) and driven by the control rod (7); a three-way valve (9) controlling the pressure in the rear chamber (4), this valve selectively connecting the rear chamber (4) to the front chamber (3) or to the second pressure (Pa) according to whether the control rod (7) is adopting, with respect to the piston (5), a relative rest position under the effect at least of the return force (Fr), or a relative actuating position under the effect of the actuating force (Fe); and a reaction member (13) receiving and transmitting the actuating force (Fe) applied by the plunger (8) and a boost force (Fa) applied by the piston (5) and resulting from an effort exerted by the controlled pressure on the moving partition (2), characterized in that the valve (9) comprises a lever (19) mounted so that it can rock with respect to the control rod (7) and having, on each side of the control rod, first and second lever arms (91, 92) respectively ending in first and second ends (901, 902) of the lever, first and second valve seats (51, 52) defined in the piston (5), first and second valve elements (61, 62) articulated to the respective first and second ends (901, 902) of the lever (90) and applied selectively to the respective first and second seats (51, 52) by relative movements directed respectively in the axial actuating direction (X+) and in the axial return direction (X−), a first communication passage (11) connecting the rear (4) and front (3) chambers through the first valve seat (51), a second communication passage (12) connecting the rear chamber (4) to the second pressure (Pa) through the second valve seat (51), a spring (93) urging at least the first lever arm (91) in the axial return direction (X−), and a stop (611) halting the movement of the first lever arm (91) in the axial return direction (X−) when the control rod (7) is in the rest position.

2. The Booster according to claim 1, characterized in that the valve elements (61, 62) are articulated to the lever (90) by means of respective rods (610, 620), and in that the stop (611) is formed by a continuation of the rod (610) of the first valve element (61) coming into contact with the rigid casing (1) when the control rod (7) is in the rest position.

3. The Booster according to claim 2, characterized in that the spring (93) is a helical spring stressed in compression and arranged between the piston (5) and the lever (90).

4. The Booster according to claim 3, characterized in that the piston (5) has a piston shank (50) passing with sealing through an opening (10) made in the casing, in that the control rod (7) is secured to a sleeve tube (14) having two ends (141, 142) via which this sleeve tube (14) is mounted to slide with sealing in the piston shank (50), in that a ring (15) is mounted to pivot on a central external surface (140) of the sleeve tube (14), and in that the two lever arms (91, 92) of the lever (90) are fixed to the ring (15) and pass through respective axial slots (501, 502) made in the piston shank (50) and situated in the rear chamber (4).

5. The Booster according to claim 4, characterized in that the ring (15) is formed of two ring halves (151, 152) slipped over pivots (143, 144) projecting from the central external surface (140) of the sleeve tube (14) and connected together by means of two connections (16, 17) via which the lever arms (91, 92) are fixed to the ring (15).
